(19) United States
(12) Patent Application Publication
(10) Pub. No.: US 2026/0289804 A1
(43) Pub. Date: Sep. 24, 2026

(54) REAL-TIME ONLINE VIDEO DEPTH ESTIMATION AT HIGH RESOLUTION

(71) Applicant: Netflix, Inc., Los Gatos, CA (US)

(72) Inventors: Gene Chou, Los Gatos, CA (US); Wenqi Xian, Los Gatos, CA (US); Ning Yu, Los Gatos, CA (US); Paul E. Debevec, Los Gatos, CA (US)

(21) Appl. No.: 19/572,675

(22) Filed: Mar. 19, 2026

Related U.S. Application Data
(60) Provisional application No. 63/775,591, filed on Mar. 21, 2025.

(51) Int. Cl. G06T 7/55; G06T 7/33; G06T 11/00

(52) U.S. Cl. CPC G06T 7/55; G06T 7/33; G06T 11/00; G06T 2207/10016; G06T 2207/20016; G06T 2207/20081

(57) ABSTRACT

A computer system may generate spatially detailed depth-related features from a higher-resolution representation of a video frame. The computer system may generate semantically informative depth-related features from a lower-resolution representation of a video frame. The computer system may generate refined spatially detailed depth-related features by selectively incorporating the semantically informative depth-related features into the spatially detailed depth-related features. The computer system may generate a dense feature representation for each video frame from the refined spatially detailed depth-related features. The computer system may temporally align the dense feature representation for a current video frame using a stateful temporal alignment model that maintains a state derived from previously processed video frames. The computer system may generate a depth map for the current video frame from the temporally aligned dense feature representation.

### CROSS-REFERENCE TO RELATED APPLICATIONS

This application claims the benefit of and priority to U.S. Provisional Patent Application Ser. No. 63/775,591 filed on 21 Mar. 2025 and entitled “REAL-TIME ONLINE VIDEO DEPTH ESTIMATION AT HIGH RESOLUTION,” which application is expressly incorporated herein by reference in its entirety.

### BACKGROUND

Depth information derived from video can be useful in a wide range of computing applications, including video editing, visual effects, augmented or mixed reality, scene understanding, and interactive media systems. In many such applications, depth information is generated from monocular video, where each video frame contains only two-dimensional image data and depth is inferred computationally.

Generating depth information from video presents technical challenges beyond those encountered in single-image processing. Video data is inherently sequential, and depth estimates produced for individual frames may vary over time due to changes in scene content, camera motion, or model uncertainty.

Further, modern video content is frequently captured or processed at high spatial resolutions. Producing depth information at such resolutions can increase computational cost and memory usage, while reducing resolution can degrade spatial detail, including object boundaries and fine structures that may be important for downstream use.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In at least one embodiment, the techniques described herein relate to a computer-implemented method that includes receiving a sequence of video frames. The method also includes generating spatially detailed depth-related features from a higher-resolution representation of each video frame using a first transformer-based encoder. Additionally, the method includes generating semantically informative depth-related features from a lower-resolution representation of each video frame using a second transformer-based encoder. The method further includes generating refined spatially detailed depth-related features by selectively incorporating, via a feature-interaction module, the semantically informative depth-related features into the spatially detailed depth-related features. In addition, the method may include generating a dense feature representation for each video frame from the refined spatially detailed depth-related features using one or more transformer-based depth prediction modules. Further, the method may include temporally aligning the dense feature representation for a current video frame using a stateful temporal alignment model that maintains a state derived from previously processed video frames, the temporally aligning including generating one or more alignment parameters configured to enforce depth-scale consistency across frames and applying the one or more alignment parameters to the dense feature representation or to depth values derived therefrom, without access to future video frames. Further still, the method may include generating a depth map for the current video frame from the temporally aligned dense feature representation.

In at least one embodiment, the techniques described herein relate to a computer system for generating depth information from streaming. The computer system may include one or more processors and one or more non-transitory computer-readable media having stored thereon executable instructions that when executed by the one or more processors configure the computer system to perform various actions. For example, the computer system can receive a sequence of video frames. The computer system may also generate spatially detailed depth-related features from a higher-resolution representation of each video frame using a first transformer-based encoder. The computer system can also generate semantically informative depth-related features from a lower-resolution representation of each video frame using a second transformer-based encoder. Additionally, the computer system can generate refined spatially detailed depth-related features by selectively incorporating, via a feature-interaction module, the semantically informative depth-related features into the spatially detailed depth-related features. The computer system may further generate a dense feature representation for each video frame from the refined spatially detailed depth-related features using one or more transformer-based depth prediction modules. In addition, the computer system may temporally align the dense feature representation for a current video frame using a stateful temporal alignment model that maintains a state derived from previously processed video frames, the temporally aligning including generating one or more alignment parameters configured to enforce depth-scale consistency across frames and applying the one or more alignment parameters to the dense feature representation or to depth values derived therefrom, without access to future video frames. Further, the computer system may generate a depth map for the current video frame from the temporally aligned dense feature representation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a schematic diagram of an example system for real-time online video depth estimation at high resolution.

FIG. 2 illustrates a schematic diagram of an example computer system for real-time online video depth estimation at high resolution.

FIG. 3 illustrates an example video frame with an associated video depth estimation.

FIG. 4 illustrates a schematic diagram of another example system for real-time online video depth estimation at high resolution.

FIG. 5 illustrates a flow chart in an example method for real-time online video depth estimation at high resolution.

FIG. 6 illustrates a flow chart of an example temporal alignment process.

### DETAILED DESCRIPTION

Modern video is displayed as a sequence of two-dimensional images that lack depth information about the objects and individuals shown in the video. Human viewers are able to intuitively distinguish objects and individuals in the foreground from those in the background. In contrast, computers analytically derive depth information from the two-dimensional images. Applications increasingly rely on accurate depth information to enable immersive and interactive experiences. For example, depth maps may be used to insert visual effects into video content, to support augmented or mixed reality experiences, to enable scene understanding for interactive or live applications, or to improve downstream video processing such as segmentation, compositing, or spatial reasoning.

Producing depth information for video, however, presents several technical challenges. Video streams are often produced at high resolutions and at real-time frame rates, placing strict constraints on latency and placing high demands on computational resources. Depth estimates should remain temporally consistent across frames; otherwise, visible flicker or scale drift between frames can degrade visual quality and reduce the usefulness of the depth data for downstream systems. At the same time, reducing resolution or model complexity to meet real-time constraints can blur fine details, such as object boundaries, thin structures, or distant elements, which are often critical for high-quality video applications.

Some previous techniques exhibit fundamental tradeoffs that prevent simultaneous achievement of high resolution, temporal consistency, and real-time performance. Single-frame depth models, when applied independently to successive frames, may produce visually accurate per-frame estimates but often exhibit temporal instability, including flicker or frame-to-frame depth-scale drift. Other techniques attempt to improve temporal consistency by processing multiple frames jointly, such as through batch-based optimization, sliding-window processing, or diffusion-style iterative refinement. However, such approaches typically require access to future frames, increased memory, or multi-frame buffering, and are therefore unsuitable for streaming or real-time deployment. Still other approaches rely on large-capacity models operating at full input resolution to maximize accuracy, but such models often incur computational costs that prevent real-time operation at high resolutions. As a result, existing solutions often fail to provide high-resolution, temporally consistent depth estimates from streaming video while satisfying real-time performance constraints.

At least some disclosed embodiments address these challenges by providing systems and methods for generating depth estimates from streaming video in a manner that is both real-time and high resolution, while maintaining temporal consistency across frames.

In one example embodiment, a video processing system receives a sequence of video frames and processes the frames in a streaming fashion, without requiring access to future frames. The system employs a depth estimation architecture that combines multiple processing paths operating at different resolutions. A first processing path operates on higher-resolution image data to preserve fine spatial details and sharp depth boundaries, while a second processing path operates on lower-resolution image data to efficiently extract more global or semantically meaningful depth information.

To ensure consistency across frames, the system further includes a temporal alignment component that leverages information from previously processed frames to align depth estimates over time. This temporal component adjusts depth outputs for each incoming frame so that relative depth relationships remain stable throughout the video sequence, even as scene content or camera motion changes.

By coordinating high-resolution spatial processing with efficient lower-resolution feature extraction and temporal alignment, the disclosed techniques enable real-time generation of depth maps for streaming video at resolutions suitable for modern video applications. These depth maps can be used directly by downstream systems-such as video editing tools, visual effects pipelines, interactive applications, or real-time decision-making systems-without requiring offline post-processing or access to an entire video sequence in advance.

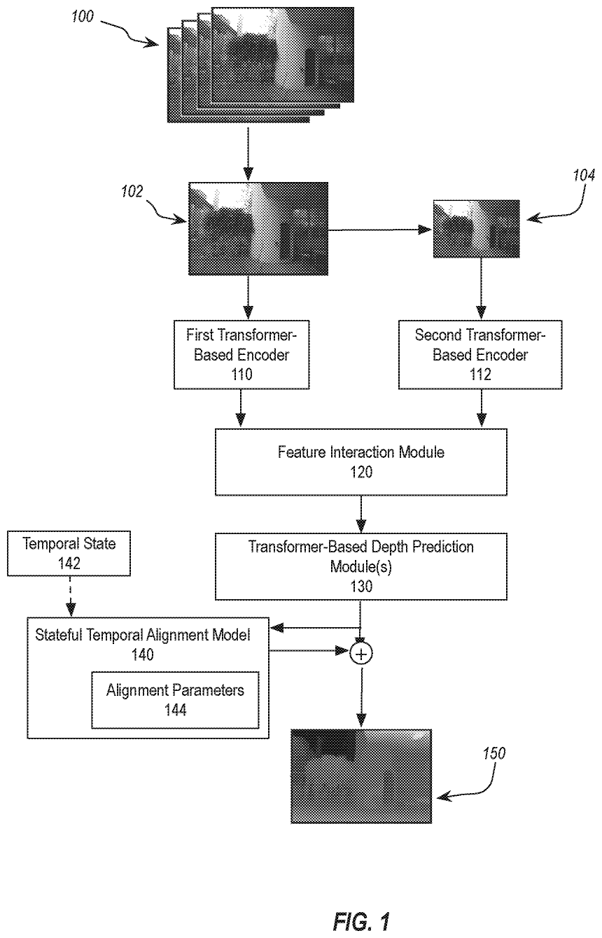

Turning now to the figures, FIG. 1 illustrates a schematic diagram of an example system for real-time online video depth estimation at high resolution. As shown, a sequence of video frames 100 is received and processed in a streaming manner. The term “sequence of video frames” refers to temporally ordered image frames captured from a video source, such as a camera, stored video file, or video stream, where each frame may be processed without requiring access to future frames in the sequence.

From the sequence of video frames 100, a higher-resolution representation 102 of each video frame is generated. A “higher-resolution representation” refers to an image representation having a greater spatial sampling density relative to a corresponding lower-resolution representation of the same video frame. The higher-resolution representation may correspond to a native spatial resolution of the video frame or may otherwise preserve fine spatial details.

Similarly, a lower-resolution representation 104 of each video frame is generated. A “lower-resolution representation” refers to an image representation derived from the same video frame having reduced spatial sampling density relative to the higher-resolution representation 102. The lower-resolution representation 104 may be generated through downsampling, pooling, resizing, or other spatial reduction operations. The terms “higher-resolution” and “lower-resolution” are relative and do not require specific pixel dimensions.

The higher-resolution representation 102 is provided to a first transformer-based encoder 110. The first transformer-based encoder 110 generates spatially detailed depth-related features. “Spatially detailed depth-related features” refers to feature representations derived from image data that encode fine-grained spatial structure within a video frame, including local depth variations and depth discontinuities between adjacent regions. Such features preserve relatively high-frequency spatial information and support accurate delineation of object boundaries and fine structures. As used herein, the term “fine structures” refers to relatively small-scale or narrow visual elements within an image that occupy a limited number of pixels and exhibit localized spatial variation. Fine structures may include thin objects, narrow geometric features, small or distant scene elements, or sharp boundary regions where depth values change over short spatial distances. Because such elements correspond to high-frequency spatial detail, they may be susceptible to degradation when image resolution is reduced or when spatial processing is performed at a coarse resolution.

The lower-resolution representation 104 is provided to a second transformer-based encoder 112. The second transformer-based encoder 112 generates semantically informative depth-related features. “Semantically informative depth-related features” refers to feature representations that encode coarse-scale or global depth relationships across multiple regions of a video frame, including contextual depth structure and relative depth ordering. These features may capture long-range dependencies and scene-level relationships without necessarily preserving fine spatial detail. In contrast, “spatially detailed depth-related features” refer to feature representations that encode fine-grained spatial structure within a video frame at a higher spatial granularity than the semantically informative depth-related features. Whereas semantically informative depth-related features emphasize coarse-scale or global depth relationships across multiple regions of the video frame, spatially detailed depth-related features emphasize localized depth variation and spatial discontinuities between adjacent regions. Accordingly, the spatially detailed depth-related features and the semantically informative depth-related features represent complementary depth information at different spatial scales, with the former encoding relatively higher-frequency spatial structure and the latter encoding relatively lower-frequency, context-level depth relationships.

Outputs of the first transformer-based encoder 110 and the second transformer-based encoder 112 are provided to a feature-interaction module 120. The “feature-interaction module” refers to a processing component configured to selectively incorporate information from one set of feature representations into another set of feature representations. The feature-interaction module 120 may implement attention mechanisms, cross-attention, gating mechanisms, learned weighting functions, conditioning operations, or other feature fusion techniques. In the illustrated embodiment, the feature-interaction module 120 incorporates semantically informative depth-related features into the spatially detailed feature representations to generate refined depth-related feature representations that preserve fine spatial detail.

The refined spatially detailed depth-related features are provided to one or more transformer-based depth prediction modules 130. The transformer-based depth prediction module 130 generates a dense feature representation for each video frame. A “dense feature representation” refers to a feature map or representation corresponding to spatial locations within the video frame and suitable for depth prediction. The transformer-based depth prediction module 130 may include one or more transformer-based decoder stages or other dense prediction architectures and is not limited to any particular internal configuration.

The dense feature representation is provided to a stateful temporal alignment model 140. The “stateful temporal alignment model” refers to a computational model that maintains and updates an internal state across successive video frames. The internal state is represented in FIG. 1 as temporal state 142. The temporal state 142 is derived from previously processed video frames and influences processing of a current video frame. A “state derived from previously processed video frames” refers to one or more data structures, memory representations, or learned hidden states that summarize information obtained from prior frames and are used during processing of the current frame.

The stateful temporal alignment model 140 generates one or more alignment parameters 144. “Alignment parameters” refers to one or more learned or computed parameters applied to feature representations or depth values to enforce depth-scale consistency across frames. “Depth-scale consistency” refers to maintaining substantially stable relative depth relationships between corresponding regions of successive video frames such that depth estimates do not exhibit frame-to-frame scale drift or discontinuous global depth shifts. Alignment parameters may include scale factors, shift values, affine transformation parameters, normalization coefficients, or other transformation parameters. In some embodiments, the alignment parameters 144 comprise a uniform scale factor and a uniform shift factor applicable across the current video frame. In other embodiments, alignment parameters may take alternative forms consistent with this disclosure.

The stateful temporal alignment model 140 applies the alignment parameters 144 to the dense feature representation or to depth values derived therefrom. In at least one embodiment, processing is performed without access to future video frames, meaning that processing of the current video frame does not depend on image data or feature representations derived from frames that have not yet been received or processed. The stateful temporal alignment model 140 may comprise a selective state-space model, which refers to a sequence modeling architecture that updates internal state over time using learned gating or selective mechanisms. The selective state-space model may maintain an internal state that is updated for each video frame based on the dense feature representation of the current video frame. In some embodiments, the selective state-space model comprises a linear-time sequence model, meaning that computational complexity per processed video frame does not increase as a function of the number of previously processed frames.

In at least one embodiment, the stateful temporal alignment model 140 operates on a reduced-resolution representation of the dense feature representation in order to improve computational efficiency while preserving temporal consistency. In particular, rather than applying temporal alignment directly at full spatial resolution, the dense feature representation Fₙ generated by the transformer-based depth prediction module 130 may first be spatially downsampled prior to temporal processing. The downsampling is used to generate a lower-resolution representation of the dense feature representation. The downsampling operation may comprise average pooling, strided convolution, learned projection, token pooling, patch merging, or other spatial reduction mechanisms. The reduced-resolution feature representation is then provided to the stateful temporal alignment model 140.

The stateful temporal alignment model 140 may update internal state and generate alignment parameters based on the reduced-resolution representation and a previously stored temporal state Hₜ₋₁ according to: Hₜ=f(Hₜ₋₁, fₙ), where f represents a learned state-update function, which may be implemented by a selective state-space model, recurrent neural network, gated recurrent unit, or other sequence modeling architecture as described above.

Based on the updated state Hₜ, the stateful temporal alignment model may generate a correction term or alignment representation cₙ at reduced resolution. The correction term may then be spatially upsampled using an upsampling operation. The upsampling operation may comprise bilinear interpolation, nearest-neighbor interpolation, learned transposed convolution, pixel-shuffle operations, or other spatial expansion mechanisms.

The upsampled correction Cₙ may then be combined with the original dense feature representation Fₙ to produce a temporally aligned representation. In one example configuration, this combination may be expressed as: fₙ_{_{align}}=Fₙ+Cₙ. In other embodiments, the correction term may instead define scale and shift parameters applied uniformly or locally across the frame, as described above. The particular mathematical form of the correction is not limiting.

Operating the stateful temporal alignment model 140 on a reduced-resolution representation fₙ may significantly reduce computational complexity and memory usage relative to performing recurrent processing at full spatial resolution. Because the alignment parameters primarily enforce global or coarse-scale depth consistency across frames, temporal alignment may be performed at reduced spatial resolution without materially degrading spatial boundary detail, which is preserved by the higher-resolution processing path.

This downsampled temporal alignment mechanism may enable real-time or near real-time operation at high input resolutions while maintaining temporal stability across frames. The temporal module may therefore represent a relatively small fraction of overall model parameters while still enforcing depth-scale consistency.

After temporal alignment, a depth map 150 for the current video frame is generated. The depth map 150 represents estimated depth values corresponding to spatial locations within the video frame and may be provided to downstream applications.

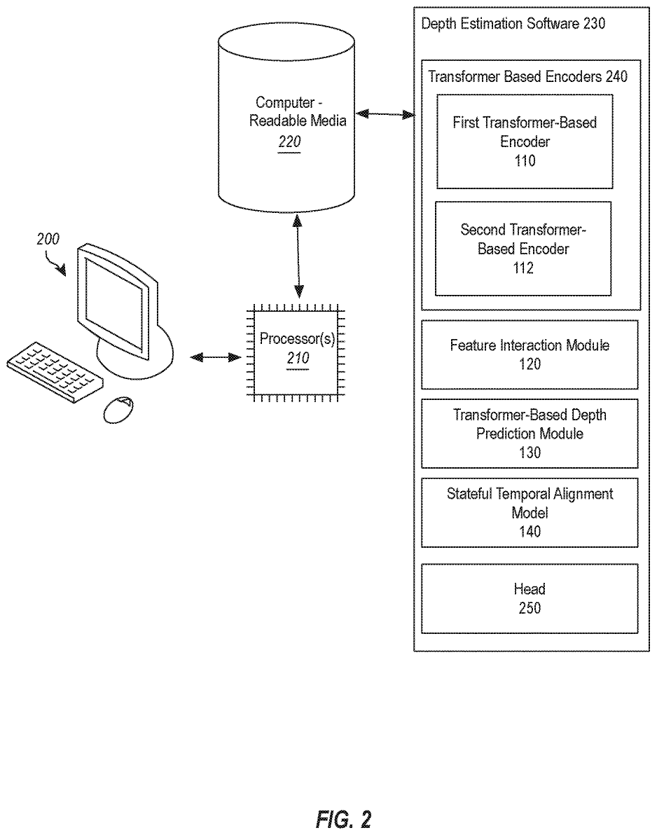

FIG. 2 illustrates an example computer system 200 configured to perform the disclosed techniques. The computer system 200 includes one or more processors 210 and one or more computer-readable media 220. The computer-readable media 220 stores depth estimation software 230. When executed by the processor(s) 210, the depth estimation software 230 configures the computer system 200 to perform operations corresponding to the components illustrated in FIG. 1.

As shown in FIG. 2, the depth estimation software 230 may include transformer-based encoders 240, including the first transformer-based encoder 110 and the second transformer-based encoder 112, the feature-interaction module 120, the transformer-based depth prediction module 130, the stateful temporal alignment model 140, and, in some embodiments, a head 250. The head 250 may perform a final projection from the temporally aligned dense feature representation to the depth map output. The computer-readable media 220 may include non-transitory storage media such as memory, magnetic storage, optical storage, or other tangible storage media. The system 200 may operate in standalone, networked, or cloud-based environments.

Together, FIGS. 1 and 2 illustrate an architecture that integrates dual-resolution spatial processing, feature-interaction, transformer-based depth prediction, and stateful temporal alignment to generate temporally consistent depth maps from a sequence of video frames 100 without requiring access to future frames.

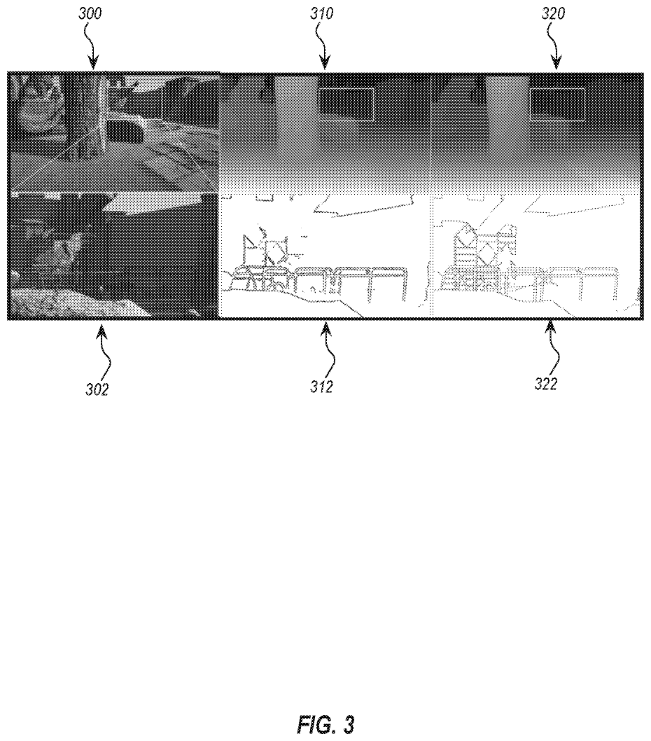

FIG. 3 illustrates example results of depth estimation. In particular, FIG. 3 includes an example video frame 300 and a zoom-in of a portion of the video frame 302. The video frame 300 represents an input image that may be processed using the disclosed dual-resolution depth estimation architecture. The zoom-in 302 highlights a localized region of the video frame 300 that includes fine spatial structures and object boundaries.

FIG. 3 further illustrates a predicted depth map 310 corresponding to the video frame 300. The predicted depth map 310 represents an example depth estimation that may be generated by the disclosed system. As shown, the predicted depth map 310 reflects relative depth differences across the scene, including depth variation between foreground and background regions. These depth differences may be informed, at least in part, by semantically informative depth-related features generated from a lower-resolution representation 104 of the video frame, which encode global or scene-level depth relationships and contextual depth structure.

FIG. 3 also illustrates a predicted boundary map 312 corresponding to the zoom-in 302. The predicted boundary map 312 represents an example identification of depth discontinuities within the localized region of the video frame 300. The predicted boundary map 312 may be generated based on spatially detailed depth-related features derived from a higher-resolution representation 102 of the video frame. Because the higher-resolution representation 102 preserves a greater amount of fine spatial structure, the spatially detailed depth-related features can encode localized depth variation and depth discontinuities between adjacent regions, enabling accurate detection of object boundaries and thin structures within the scene.

For reference, FIG. 3 further includes an actual depth map 320 and an actual boundary map 322. The actual depth map 320 corresponds to ground truth depth values associated with the video frame 300, and the actual boundary map 322 corresponds to ground truth boundary information associated with the zoom-in 302. The predicted depth map 310 and predicted boundary map 312 are provided for comparison with the corresponding ground truth maps to illustrate example outputs that may be achieved using the disclosed techniques. The inclusion of these example results is intended to provide contextual understanding of how combining semantically informative depth-related features and spatially detailed depth-related features can contribute to both globally coherent depth estimation and accurate local boundary detection, without limiting the scope of the claimed subject matter.

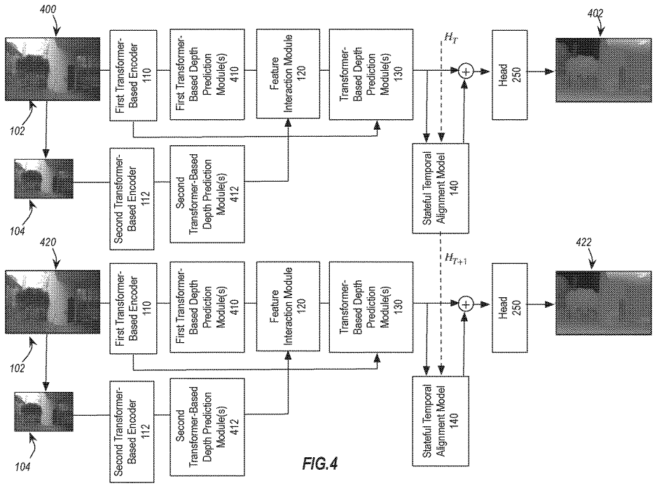

FIG. 4 illustrates the operation of the disclosed depth estimation architecture across sequential video frames in order to demonstrate, among other aspects, the temporal alignment and state propagation in a streaming configuration. In particular, FIG. 4 depicts the processing of Frame N 400 and the immediately subsequent Frame N+1 420 to illustrate how at least one disclosed embodiment operates, including how depth estimates are temporally stabilized while operating without access to future video frames.

As shown, Frame N 400 is processed through the dual-resolution feature generation and feature-interaction architecture described with respect to FIG. 1. A higher-resolution representation 102 of Frame N 400 is provided to a first transformer-based encoder 110 to generate spatially detailed depth-related features. In parallel, a lower-resolution representation 104 of Frame N 400 is provided to a second transformer-based encoder 112 to generate semantically informative depth-related features. Each transformer-based encoder may comprise a vision transformer architecture configured to operate on image tokens derived from the corresponding representation.

The first transformer-based encoder 110 operating on the higher-resolution representation 102 is configured to preserve fine spatial structure and localized depth variation. In certain implementations, the transformer-based encoder 110 may be a lightweight or smaller-capacity vision transformer optimized for higher-resolution inputs, thereby maintaining computational efficiency while preserving local detail. The second transformer-based encoder 112 operates on the lower-resolution representation 104 and may use a similar transformer architecture, although the depth, number of layers, embedding dimension, or number of attention heads may differ. The lower-resolution representation reduces computational burden and enables the transformer-based encoder 112 to capture longer-range spatial dependencies and scene-level context. By processing fewer tokens at coarser resolution, the second transformer-based encoder 112 may encode global depth relationships, such as relative depth ordering between foreground and background objects, within the semantically informative depth-related features.

In at least one embodiment, the transformer-based encoder architecture may be implemented using a depth estimation backbone derived from a single-image depth model. In one example configuration, a model architecture consistent with Depth Anything v2 (DAv2) may be employed as a base model for feature extraction. Such a configuration may include a pretrained vision transformer encoder, for example, a DINOv2-based Vision Transformer (ViT), coupled with a dense prediction transformer (DPT) decoder (e.g., first transformer-based depth prediction module(s) 410 and second transformer-based depth prediction module(s) 412).

In this example configuration, an input image is tokenized into a sequence of patch embeddings, which are then processed through a multi-layer Vision Transformer encoder. For a 24-layer transformer model, intermediate feature representations may be extracted from multiple depths within the transformer stack. For example, feature outputs from transformer layers 5, 12, 18, and 24 may be collected. These intermediate representations capture information at varying receptive field scales and semantic depths. Relatively shallower layers tend to encode finer spatial structure and local image detail, while relatively deeper layers encode more abstract and semantically meaningful scene structure.

The collected intermediate feature representations may then be provided to the first transformer-based depth prediction module(s) 410 and the second transformer-based depth prediction module(s) 412, which may comprise one or more DPT-style decoders. In at least one embodiment, first transformer-based depth prediction module(s) 410 and second transformer-based depth prediction module(s) 412 may represent internal decoder stages of the transformer-based depth prediction module(s) 130 and are not separate required modules. The one or more DPT-style decoders fuse multi-scale transformer features using residual convolutional units and spatial refinement operations to generate a dense depth prediction. In representative form, if F₅, F₁₂, F₁₈, and F₂₄ denote the intermediate transformer outputs, the decoder may perform learned transformations and hierarchical fusion operations such that: D=DPT(F₅, F₁₂, F₁₈, F₂₄), where D represents a dense depth map prediction corresponding to the input image.

This configuration may enable generation of high-resolution and detailed depth maps from a single frame. However, when such a single-image model is applied independently to sequential frames of a video, the resulting depth estimates may exhibit temporal inconsistency, including scale drift and flickering effects. This may occur when the single-image model does not enforce a common depth scale across frames and lacks a mechanism for maintaining temporal state.

Although the foregoing describes one example configuration employing a DINOv2-based ViT encoder and DPT decoder with intermediate feature extraction from selected transformer layers, the disclosed techniques are not limited to this configuration. Instead, this example embodiment is provided for illustrative purposes and clarity. Alternative transformer architectures, alternative layer selections, hierarchical transformers, window-based attention models, hybrid convolution-transformer architectures, or other dense prediction decoders may be employed while maintaining the dual-resolution feature extraction and temporal alignment principles described herein. In some embodiments, the transformer-based encoders may be pre-trained on large-scale image datasets and fine-tuned for depth estimation. The number of transformer layers, attention heads, embedding dimensions, and patch sizes may be selected based on resolution constraints, memory availability, or latency targets. In certain implementations, convolutional preprocessing layers may be applied prior to tokenization to enhance local feature extraction. Conversely, in other embodiments, convolutional encoders or hybrid architectures may be substituted for one or both transformer-based encoders while preserving the dual-resolution and feature specialization principles described herein.

Through the use of separate transformer-based encoders operating on different spatial resolutions, the disclosed architecture enables parallel extraction of complementary depth representations: spatially detailed depth-related features encoding localized structural depth information and semantically informative depth-related features encoding broader contextual depth relationships. These feature sets are subsequently combined via the feature-interaction module 120 to generate refined depth-related features suitable for dense depth prediction.

The feature-interaction module 120 selectively incorporates the semantically informative depth-related features into the spatially detailed depth-related features to produce refined spatially detailed depth-related features. In at least one embodiment, the feature-interaction module 120 operates within a hybrid dual-stream architecture in which a first stream processes higher-resolution video frames using a comparatively lightweight backbone and a second stream processes lower-resolution video frames using a comparatively higher-capacity backbone. The first stream may be configured to operate on full-resolution frames (for example, 2K resolution) to preserve spatial sharpness and boundary detail, while the second stream may process downsampled frames (for example, with a shorter side resized to approximately 518 pixels) to extract semantically rich and numerically accurate depth features at reduced computational cost.

In at least one embodiment, the feature-interaction module 120 implements a cross-attention mechanism that fuses intermediate features from the two streams. Let F_{S}_{ᵢ} denote an intermediate feature representation at layer i of the higher-resolution stream, and let F_{L}_{ᵢ} denote a corresponding intermediate feature representation at layer i of the lower-resolution stream. The fused feature representation F_{fused}_{ᵢ} may be computed according to:

$${F}_{{fused}_{i}} = CrossAttn ( Q = {F}_{{S}_{i}} , KV = {F}_{{L}_{i}} ) , \qquad Equation 1$$

where Q represents query features derived from the higher-resolution stream, and K and V represent key and value features derived from the lower-resolution stream. In this configuration, the higher-resolution features are selectively modulated based on semantically informative features extracted from the lower-resolution stream. In some implementations, the cross-attention module may be initialized such that, at an initial training stage, F_{fused}_{ᵢ}≈F_{S}_{ᵢ}, for example through zero-initialization of attention weights, thereby allowing the higher-resolution stream to gradually incorporate semantic information without abrupt parameter changes.

The feature-interaction module 120 may be positioned at one or more intermediate stages within the depth prediction pipeline, such as after an initial decoding layer but prior to subsequent decoding stages. The intermediate feature maps may maintain a consistent token sequence length corresponding to the higher-resolution representation, allowing cross-attention to operate between sequences of lengths M×N, where M corresponds to the number of tokens in the higher-resolution feature map and N corresponds to the number of tokens in the lower-resolution feature map. Because boundary regions typically comprise a relatively small percentage of pixels in a frame, preservation of high-resolution spatial features allows for the maintaining of sharpness, whereas global numerical depth accuracy may be influenced more strongly by semantically informative features extracted at lower resolution.

Although cross-attention is one implementation of the feature-interaction module 120, other mechanisms may be used. For example, the feature-interaction module may implement learned gating, additive or multiplicative feature modulation, affine feature transformation, channel-wise scaling, concatenation followed by learned projection, or other learned fusion techniques that modify the spatially detailed depth-related features based on the semantically informative depth-related features. The feature-interaction module 120 is not limited to any particular attention formulation or transformer architecture, provided that information from the semantically informative feature stream influences the spatially detailed feature stream to generate refined spatially detailed depth-related features.

By combining a high-resolution spatial stream with a lower-resolution semantic stream and fusing their intermediate representations via the feature-interaction module 120, the disclosed architecture enables the generation of refined spatially detailed depth-related features. The refined spatially detailed depth-related features generated by the feature-interaction module 120 are provided to the transformer-based depth prediction module 130. The transformer-based depth prediction module 130 is configured to generate a dense feature representation corresponding to spatial locations of the video frame and ultimately to produce a depth map. The dense feature representation may be represented as a tensor F∈ [symbol] \hat{ }{H×W×C}, where H and W correspond to spatial dimensions of the video frame and C corresponds to a feature channel dimension.

In certain implementations, the transformer-based depth prediction module 130 comprises a dense prediction transformer (DPT)-style decoder that fuses multi-scale transformer features to generate spatially aligned depth representations. In one example configuration, intermediate feature outputs from multiple layers of a transformer backbone are collected and provided to the decoder. For instance, where a 24-layer vision transformer backbone is used, intermediate outputs from selected layers (for example, layers 5, 12, 18, and 24) may be extracted. Shallower layers may encode relatively fine spatial structure, while deeper layers encode more abstract semantic content. These multi-level feature representations may be combined in the depth prediction module 130 using learned projection layers and residual convolutional units to progressively reconstruct a spatially dense representation.

In some embodiments, the transformer-based depth prediction module 130 comprises a stack of transformer decoder blocks configured to operate directly on spatial tokens corresponding to the refined spatially detailed depth-related features. Each decoder block may include multi-head self-attention, cross-attention (if applicable), feed-forward layers, normalization layers, and residual connections. In such embodiments, the dense feature representation may be formed by reshaping token outputs back into spatial feature maps corresponding to the video frame resolution.

The transformer-based depth prediction module 130 may also include convolutional refinement layers that operate after transformer processing to enhance local spatial coherence. Residual convolutional units may be used to improve boundary sharpness and reduce artifacts introduced during upsampling. In certain implementations, the decoder maintains the same spatial token length as the input to preserve correspondence with the higher-resolution representation.

Although the transformer-based depth prediction module 130 may be implemented using a DPT-style architecture in some embodiments, it is not limited to any particular decoder configuration. Alternative embodiments may include hierarchical transformer decoders, window-based transformer decoders, hybrid convolution-transformer decoders, U-Net-style architectures with transformer bottlenecks, or other dense prediction networks configured to map refined feature representations to depth maps. The number of decoder stages, attention heads, embedding dimensions, and upsampling operations may be selected based on target resolution, memory constraints, or latency requirements.

In some embodiments, the transformer-based depth prediction module 130 may operate at full input resolution and generate a depth map directly. In other embodiments, the module may generate an intermediate dense feature representation at reduced resolution, followed by learned upsampling or interpolation to produce the final depth map. The final projection from dense feature representation to depth values may be implemented using linear layers, convolutional layers, multilayer perceptrons, or other learned mappings.

In operation, the transformer-based depth prediction module 130 provides a spatially dense and semantically coherent depth representation that serves as the input to the stateful temporal alignment model 140. By combining multi-scale transformer features with spatial reconstruction mechanisms, the module 130 enables generation of high-resolution depth estimates suitable for subsequent temporal alignment while preserving both fine-grained boundary detail and global depth structure.

The dense feature representation for Frame N 400 is then provided to the stateful temporal alignment model 140. As defined previously, the stateful temporal alignment model maintains and updates an internal state derived from one or more previously processed video frames. In FIG. 4, the internal state after processing Frame N 400 is denoted Hₜ. The internal state Hₜ may comprise one or more learned hidden representations, memory tensors, or state variables summarizing temporal information from prior frames in the sequence.

In general form, the state update may be expressed as: Hₜ=f(Hₜ₋₁, Fₙ), where Hₜ₋₁ represents a previously stored temporal state, Fₙ represents the dense feature representation for Frame N 400, and f denotes a learned state-update function. The function f may be implemented by a selective state-space model, recurrent neural network, gated recurrent unit, long short-term memory network, causal transformer block, or other sequence modeling architecture capable of maintaining state across time. In certain embodiments, the stateful temporal alignment model operates as a linear-time sequence model, meaning that the computational complexity and memory required per processed frame remain substantially constant and do not increase as a function of the number of previously processed frames. This bounded computational behavior enables online processing of high-resolution video sequences.

Using the updated temporal state Hₜ, the stateful temporal alignment model 140 generates one or more alignment parameters 144. As previously defined, alignment parameters are parameters applied to feature representations or to depth values derived therefrom in order to enforce depth-scale consistency across frames. Depth-scale consistency refers to maintaining stable relative depth relationships between corresponding regions of successive frames so as to reduce frame-to-frame scale drift or discontinuous global depth shifts.

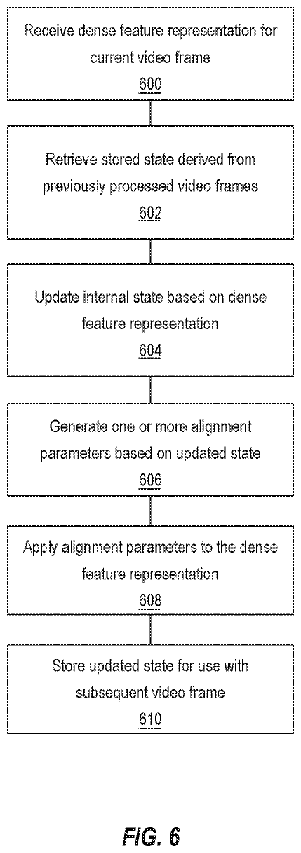

In certain embodiments, the alignment parameters comprise a uniform scale factor sₙ and a uniform shift factor bₙ applicable across the current video frame. In such embodiments, the stateful temporal alignment model 140 generates the uniform scale factor sₙ and the uniform shift factor bₙ for each video frame based on the internal state derived from one or more previously processed video frames, as described with respect to FIG. 6. The internal state may be maintained and updated for each video frame by a selective state-space model, in which the state is updated as a function of the dense feature representation and prior state information. The uniform scale factor sₙ and uniform shift factor bₙ may be applied uniformly to all pixels of the current video frame, such that a temporally aligned depth estimate Dₙ′ may be expressed as Dₙ′=sₙ·Dₙ+bₙ, where Dₙ represents depth values derived from the dense feature representation Fₙ for Frame N 400. In this manner, successive dense feature representations or derived depth maps may be aligned to a common depth scale across the sequence of video frames, thereby reducing depth-scale drift between frames. In other embodiments, the alignment parameters may include more general affine transformation parameters, channel-wise scaling factors, normalization coefficients, or other learned transformations applied to the dense feature representation Fₙ or to depth values derived therefrom. The alignment parameters may be generated per frame based on the maintained internal state, and the disclosure is not limited to any particular mathematical form of alignment parameter or state-update mechanism.

After alignment parameters are generated and applied, the head 250 may produce the output depth map 402 corresponding to Frame N 400. The updated temporal state Hₜ is stored within the stateful temporal alignment model 140 for use in processing subsequent frames.

Frame N+1 420 is then processed using the same architectural components. Spatially detailed depth-related features and semantically informative depth-related features are generated for Frame N+1 420, refined through the feature-interaction module 120, and transformed into a dense feature representation Fₙ₊₁ by the transformer-based depth prediction module 130.

The stateful temporal alignment model 140 retrieves the previously stored state Hₜ and updates it according to: Hₜ₊₁=f(Hₜ, Fₙ₊₁). Alignment parameters for Frame N+1 420 are generated based on the updated state Hₜ₊₁ and applied to the dense feature representation or to derived depth values to produce output depth map 422.

In at least one embodiment, processing of Frame N+1 420 is performed without access to future video frames. The output depth map 422 may depend only on Frame N+1 420 and on information derived from previously processed frames, including Frame N 400 and any earlier frames. No information from subsequent frames is used. This causal, streaming configuration reduces memory requirements and avoids the need for batch optimization over multiple frames.

By combining dual-resolution spatial processing with stateful temporal alignment that generates alignment parameters enforcing depth-scale consistency across frames, the disclosed architecture addresses the technical problem of producing high-resolution depth estimates that remain temporally stable in streaming video without requiring access to future frames. The maintenance and update of internal state across frames enables reduction of depth-scale drift while preserving fine spatial detail derived from higher-resolution representations.

Although FIG. 4 illustrates two sequential frames for clarity, the disclosed techniques are not limited to two frames and may operate over arbitrarily long video sequences. The internal state may summarize information from multiple prior frames and may be updated at each time step. The alignment parameters may be generated and applied independently for each frame based on the maintained state, while preserving causal processing.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

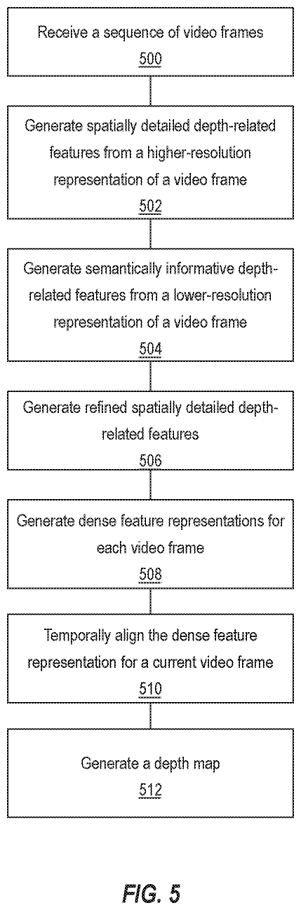

Referring now to FIG. 5, an example method is illustrated for generating depth information from a sequence of video frames. The method may be performed by a computer system such as computer system 200 described with respect to FIG. 2, including one or more processors 210 and computer-readable media 220 storing depth estimation software 230. At step 500, the method includes receiving a sequence of video frames, corresponding to the sequence of video frames 100 illustrated in FIG. 1. Each video frame may be processed as it is received, and the method may be applied iteratively to successive frames in the sequence. In some embodiments, video frames are received from a live capture device, a stored video source, or a network stream. As further illustrated in FIG. 4, Frame N 400 and Frame N+1 420 represent two successive frames within the sequence of video frames 100.

At step 502, the method may include generating spatially detailed depth-related features from a higher-resolution representation of each video frame using a first transformer-based encoder 110 shown in FIG. 1. The higher-resolution representation 102 may correspond to a native spatial resolution of the video frame or another representation preserving a relatively high spatial sampling density. The first transformer-based encoder 110 may process this representation to produce spatially detailed depth-related features that encode localized depth variation and depth discontinuities. As described above with respect to FIG. 1, such spatially detailed depth-related features may be effective for representing fine structures and object boundaries.

At step 504, the method includes generating semantically informative depth-related features from a lower-resolution representation of each video frame using a second transformer-based encoder 112 shown in FIG. 1. The lower-resolution representation 104 may be generated by downsampling or otherwise reducing the spatial resolution of the video frame. The second transformer-based encoder 112 may process the lower-resolution representation 104 to produce semantically informative depth-related features encoding coarse-scale or global depth relationships. By operating at reduced spatial resolution, the second transformer-based encoder 112 may capture long-range contextual depth structure while maintaining computational efficiency.

At step 506, the method includes generating refined spatially detailed depth-related features by selectively incorporating, via the feature-interaction module 120 shown in FIG. 1, the semantically informative depth-related features into the spatially detailed depth-related features. The feature-interaction module 120 may implement cross-attention or other learned fusion mechanisms. In embodiments implementing cross-attention, spatially detailed features may serve as query representations and semantically informative features may serve as key and value representations, as described above with respect to FIG. 1 and FIG. 4. The resulting refined spatially detailed depth-related features encode both fine spatial detail and globally consistent depth structure.

At step 508, the method includes generating a dense feature representation for each video frame from the refined spatially detailed depth-related features using one or more transformer-based depth prediction module(s) 130 illustrated in FIG. 1. The transformer-based depth prediction module 130 may include one or more transformer-based processing stages configured to transform the refined spatially detailed depth-related features into a spatially aligned dense feature representation. As described in connection with FIG. 1, the dense feature representation may correspond to spatial locations of the video frame and may be subsequently projected to depth values. The dense feature representation generated at step 508 may correspond to the dense feature representation described in connection with FIG. 4.

At step 510, the method includes temporally aligning the dense feature representation for the current video frame using the stateful temporal alignment model 140 shown in FIGS. 1 and 4. The stateful temporal alignment model 140 maintains a temporal state 142 derived from previously processed video frames. As illustrated in FIG. 4, after processing Frame N 400, the temporal state may be represented as Hₜ, and after processing Frame N+1 420, the temporal state may be represented as Hₜ₊₁. The stateful temporal alignment model 140 updates the temporal state based on the dense feature representation for the current frame and previously stored state information, consistent with the state update process illustrated in FIG. 6 at steps 602 and 604.

As further illustrated in FIG. 6, the temporal alignment at step 510 includes generating one or more alignment parameters 144 based on the updated temporal state. In FIG. 6, this corresponds to step 606. The alignment parameters 144 are configured to enforce depth-scale consistency across frames. In certain embodiments, the alignment parameters 144 comprise a uniform scale factor and a uniform shift factor, as illustrated in FIG. 1 and described in connection with step 606 of FIG. 6. In other embodiments, the alignment parameters 144 may include alternative transformation parameters applied to the dense feature representation or to depth values derived therefrom.

The alignment parameters 144 may be applied to the dense feature representation or to depth values derived therefrom, corresponding to step 608 in FIG. 6. This operation produces a temporally aligned depth representation for the current video frame. By applying alignment parameters derived from the maintained temporal state 142, the system may reduce depth-scale drift and improve temporal consistency between successive frames. This alignment may be performed without access to future video frames. As illustrated in FIG. 4, processing of Frame N+1 420 may depend only on Frame N 400 and earlier frames via the temporal state, and does not rely on frames beyond Frame N+1 420.

At step 512, the method includes generating a depth map for the current video frame from the temporally aligned dense feature representation. This corresponds to generation of depth map 150 in FIG. 1 and depth maps 402 and 422 in FIG. 4. The depth map may be generated using a projection head, such as head 250 shown in FIG. 2, or another learned mapping from the dense feature representation to per-pixel depth values.

The method 500 may then proceed to process the next video frame in the sequence, updating the temporal state 142 as illustrated in FIG. 6 at step 610 and propagating the updated state forward as illustrated in FIG. 4. Through coordinated operation of dual-resolution feature extraction (FIG. 1, elements 102, 104, 110, 112), feature-interaction (FIG. 1, element 120), dense depth prediction (FIG. 1, element 130), and stateful temporal alignment (FIG. 1 and FIG. 4, element 140 with state 142 and alignment parameters 144), the disclosed method 500 may provide high-resolution depth estimation in a streaming environment while reducing temporal inconsistency without requiring access to future video frames.

Referring now to FIG. 6, an example temporal alignment process 600 is illustrated. The process shown in FIG. 6 corresponds to an example operation of the stateful temporal alignment model 140 illustrated in FIGS. 1 and 4. The temporal alignment process 600 may be executed for each video frame in the sequence of video frames 100.

At step 600, the stateful temporal alignment model 140 receives a dense feature representation for a current video frame. As described above with respect to FIG. 1 and FIG. 4, the dense feature representation may be generated by the transformer-based depth prediction module 130 and corresponds to spatial locations of the video frame. The dense feature representation may be represented as Fₙ∈ [symbol] \hat{ }{H×W×C}, where H and W correspond to spatial dimensions and C corresponds to feature channels. This dense feature representation contains spatially aligned depth-related information that is subject to temporal alignment.

At step 602, the stateful temporal alignment model 140 retrieves a stored temporal state derived from previously processed video frames. The stored temporal state corresponds to the temporal state 142 shown in FIG. 1 and to the state values Hₜ and Hₜ₊₁ illustrated in FIG. 4. As previously defined, the temporal state 142 comprises one or more data structures, hidden representations, or learned internal variables summarizing information derived from one or more previously processed video frames. The temporal state may encode information relating to global depth scale, relative scene geometry, camera motion, or other temporal characteristics affecting depth stability.

At step 604, the stateful temporal alignment model 140 updates the internal state based on the dense feature representation of the current video frame. In general form, this update may be expressed as: Hₜ=f(Hₜ₋₁, Fₙ), where Hₜ₋₁ represents the previously stored state, Fₙ represents the dense feature representation for the current video frame, and f represents a learned state-update function. The function f may be implemented using a selective state-space model or using other sequence modeling architectures such as recurrent neural networks, gated recurrent units, long short-term memory networks, causal transformer-based temporal modules, or equivalent architectures capable of maintaining state across frames.

In at least one embodiment, the state-update function is configured to operate as a linear-time sequence model. In such embodiments, computational complexity and memory usage per processed video frame remain substantially bounded and do not increase as a function of the number of previously processed frames. This property enables high-resolution depth estimation to be performed in a streaming environment without requiring storage or reprocessing of the entire video sequence.

At step 606, the stateful temporal alignment model 140 generates one or more alignment parameters 144 based on the updated temporal state. The alignment parameters correspond to the alignment parameters 144 illustrated in FIG. 1. As described in connection with FIG. 1 and FIG. 4, the alignment parameters are configured to enforce depth-scale consistency across frames. In one example embodiment, the alignment parameters comprise a uniform scale factor sₙ and a uniform shift factor bₙ applicable across the current video frame. In such embodiments, temporally aligned depth values Dₙ′ may be computed as: Dₙ′=sₙ·Dₙ+bₙ, where Dₙ represents depth values derived from the dense feature representation Fₙ. However, the alignment parameters are not limited to uniform scale and shift factors. In alternative embodiments, the alignment parameters may include affine transformation coefficients, channel-wise scaling factors, normalization parameters, or other learned transformation parameters applied to the dense feature representation or to derived depth values.

At step 608, the alignment parameters are applied to the dense feature representation or to depth values derived therefrom. This operation produces a temporally aligned representation that reduces frame-to-frame depth-scale drift. The application of alignment parameters at step 608 corresponds to the additive combination shown schematically in FIG. 1, where outputs of the transformer-based depth prediction module 130 and the stateful temporal alignment model 140 are combined prior to generation of the depth map 150. The application of alignment parameters may be implemented through additive, multiplicative, affine, or other learned transformations consistent with the disclosure.

At step 610, the updated temporal state is stored for use in processing a subsequent video frame. The stored state is then used when processing the next frame in the sequence, as illustrated in FIG. 4, where the temporal state Hₜ produced after processing Frame N 400 is used when processing Frame N+1 420. As shown in FIG. 4, the temporal alignment process may operate without access to future video frames. That is, processing of the current video frame may depend only on the dense feature representation for that frame and on the stored temporal state derived from previously processed frames.

The temporal alignment process 600 addresses the technical problem of temporal instability in per-frame depth estimation. When depth is estimated independently for each frame using only spatial processing (for example, as shown in FIG. 3), depth values may exhibit scale drift or flicker across frames due to changes in scene content, viewpoint, or model uncertainty. By maintaining and updating a temporal state 142 and generating alignment parameters 144 that enforce depth-scale consistency, the disclosed process may reduce such instability while preserving the high-resolution spatial detail generated by the higher-resolution representation 102 and first transformer-based encoder 110.

Although FIG. 6 illustrates a particular sequence of steps 600-610, alternative implementations are contemplated. For example, generation of alignment parameters may be performed jointly with state update within a unified temporal module. In other embodiments, alignment parameters may be generated directly from the prior temporal state and the current dense feature representation without explicitly separating update and generation steps. The steps illustrated in FIG. 6 are provided for explanatory clarity and are not intended to limit the scope of the disclosed temporal alignment functionality.

Through the integration of the temporal alignment process 600 with the dual-resolution feature extraction and depth prediction components described in FIGS. 1, 4, and 5, the disclosed system provides high-resolution depth maps that remain temporally consistent across streaming video frames while operating without access to future frames.

In certain embodiments, the dual-resolution architecture and stateful temporal alignment model described herein may be trained using a multi-stage training procedure. The training procedure may be configured to preserve the performance of pre-trained spatial depth estimation backbones while enabling the temporal alignment model and feature-interaction mechanisms to learn temporally consistent depth representations.

In one example configuration, the system may be trained in a first stage in which the stateful temporal alignment model is trained independently or jointly with a lightweight spatial processing stream at reduced spatial resolution. During this stage, training data may include video sequences with corresponding ground truth or pseudo-ground-truth depth annotations. The temporal alignment model may learn to generate alignment parameters that reduce depth-scale drift across frames while preserving per-frame spatial accuracy.

In certain embodiments, during an initial stage of training, a larger-capacity spatial model operating at reduced resolution may be trained or fine-tuned separately to produce semantically informative depth-related features. The larger-capacity model may be configured to emphasize numerical depth accuracy, while a smaller-capacity spatial model operating at higher resolution may be configured to emphasize spatial detail and boundary sharpness.

In a subsequent training stage, the larger-capacity model may be held fixed (for example, by freezing its weights) while the smaller-capacity model and feature-interaction module are trained to incorporate semantically informative features from the larger-capacity model. Freezing the larger-capacity model during this stage may stabilize training and preserve previously learned semantic depth representations while enabling the higher-resolution stream to adapt its intermediate features.

In certain embodiments, the stateful temporal alignment model may be initialized such that its output initially produces no modification to the dense feature representation. For example, output layers of the temporal alignment model that generate alignment parameters may be initialized to zero or near-zero values. Under such initialization, the initial temporally aligned depth output may be substantially identical to the per-frame depth estimate generated by the transformer-based depth prediction module prior to temporal alignment. This initialization strategy may allow the model to begin training from a valid single-frame depth estimate and to gradually learn temporal corrections without destabilizing pre-trained spatial representations.

In embodiments where alignment parameters comprise a uniform scale factor and a uniform shift factor, zero-initialization may correspond to initializing the scale factor to approximately one and the shift factor to approximately zero. In other embodiments, zero-initialization may correspond to initializing additive correction terms to zero. The particular initialization strategy is not limiting, provided that early training iterations do not substantially degrade pre-trained per-frame depth predictions.

Training may include minimizing a depth regression loss between predicted depth maps and ground truth depth maps, optionally combined with additional regularization terms encouraging temporal consistency across frames. In certain embodiments, training data may include synthetic video sequences, real-world video sequences, or combinations thereof. Training may also include resolution augmentation, temporal stride variation, or other techniques configured to improve generalization across different motion patterns and scene structures.

Although a two-stage training procedure is described, alternative training strategies may be employed. For example, the spatial feature extraction components and temporal alignment model may be trained jointly from random initialization, or pre-trained backbones may be fine-tuned together with the temporal alignment model in a single stage. The order of freezing and unfreezing components may vary. The disclosed techniques are not limited to any particular training schedule.

The methods and systems described herein may be implemented using one or more computing systems comprising one or more processors and one or more computer-readable media. In certain embodiments, the computer-readable media comprise non-transitory computer-readable storage media storing computer-executable instructions that, when executed by the one or more processors, cause the computing system to perform one or more of the acts described herein. The disclosed subject matter may be embodied as a method, system, device, or non-transitory computer-readable storage medium. Unless otherwise specified, the described functionality may be implemented in hardware, software, firmware, or any combination thereof.

The computing system may operate in a standalone configuration or may be interconnected with other computing systems over one or more networks. Network connections may include wired or wireless communication mechanisms, including local area networks, wide area networks, cellular networks, or other data communication networks. Such interconnections may enable access to remote services, distributed processing resources, model hosting environments, or data repositories.

In some embodiments, the disclosed techniques may be implemented in distributed or cloud-based environments. Cloud computing environments may provide on-demand access to configurable computing resources, including processing units, storage systems, accelerators, or application services. Training and inference operations may be performed on centralized servers, edge devices, or combinations thereof.

Computing systems may include general-purpose or special-purpose processing resources, including central processing units (CPUs), graphics processing units (GPUs), tensor processing units (TPUs), neural processing units (NPUs), digital signal processors (DSPs), field-programmable gate arrays (FPGAs), application-specific integrated circuits (ASICs), or other programmable or fixed-function devices. Certain embodiments may execute vectorized, parallelized, or accelerator-optimized operations to perform matrix multiplications, attention operations, convolutional operations, or other computational primitives.

As used herein, “non-transitory computer-readable storage media” refers to physical storage media that retain information in a non-transient manner and expressly excludes propagating signals. Such media may include memory devices, magnetic storage, optical storage, solid-state storage, or other tangible storage mechanisms capable of storing instructions or data structures.

Computer-executable instructions may include source code, object code, intermediate representations, configuration files, model definitions, computational graphs, learned parameters, or other machine-interpretable representations. In certain embodiments, such instructions configure one or more artificial intelligence or machine learning models used in connection with the disclosed techniques. The term “module,” “component,” or “engine” refers to hardware, software, firmware, or combinations thereof, unless expressly stated otherwise.

Machine learning models described herein may include neural networks, transformer-based models, convolutional architectures, recurrent architectures, state-space models, or other statistical or learned models. Training may involve supervised, unsupervised, semi-supervised, self-supervised, or reinforcement-based approaches. Training and inference may be performed locally or in distributed computing environments.

In some embodiments, different portions of the described functionality may be performed by different computing systems or processors, whether co-located or distributed. Training systems and inference systems may be distinct, and model parameters generated during training may be deployed to separate inference systems.

Certain embodiments may improve the functioning of computing systems by reducing computational complexity, reducing memory usage, improving temporal stability of depth estimation, reducing latency, or improving processing efficiency. Execution of the described instructions may transform a general-purpose processor into a special-purpose computing device configured to perform the disclosed operations.

The invention may be embodied in other specific forms without departing from its essential characteristics. The described embodiments are illustrative and not restrictive. The scope of the invention is defined by the appended claims, and all equivalents thereof are intended to be embraced within their scope.

What is claimed is:

1. A computer-implemented method comprising:
receiving a sequence of video frames;
generating spatially detailed depth-related features from a higher-resolution representation of a current video frame selected from the sequence of video frames using a first transformer-based encoder;
generating semantically informative depth-related features from a lower-resolution representation of the current video frame using a second transformer-based encoder;
generating refined spatially detailed depth-related features by selectively incorporating, via a feature-interaction module, the semantically informative depth-related features into the spatially detailed depth-related features;
generating a dense feature representation for the current video frame from the refined spatially detailed depth-related features using one or more transformer-based depth prediction modules;
temporally aligning the dense feature representation for the current video frame using a stateful temporal alignment model that maintains a state derived from previously processed video frames, the temporally aligning including generating one or more alignment parameters configured to enforce depth-scale consistency across frames and applying the one or more alignment parameters to the dense feature representation or to depth values derived therefrom, without access to future video frames; and
generating a depth map for the current video frame from the temporally aligned dense feature representation.

2. The computer-implemented method of claim 1, wherein the stateful temporal alignment model comprises a selective state-space model.

3. The computer-implemented method of claim 2, wherein the selective state-space model maintains an internal state that is updated based on the dense feature representation of the current video frame.

4. The computer-implemented method of claim 2, wherein the one or more alignment parameters comprise a uniform scale factor and a uniform shift factor applicable across the current video frame.

5. The computer-implemented method of claim 2, wherein the selective state-space model comprises a linear-time sequence model.

6. The computer-implemented method of claim 4, wherein the uniform scale factor and the uniform shift factor are generated for the current video frame based on the state derived from the previously processed video frames.

7. The computer-implemented method of claim 1, further comprising generating augmented visual content by compositing a virtual object into the current video frame based on the depth map for the current video frame.

8. The computer-implemented method of claim 1, wherein:
the spatially detailed depth-related features correspond to feature representations derived from the higher-resolution representation prior to spatial downsampling, and
the semantically informative depth-related features are derived from the lower-resolution representation to capture scene-level depth relationships.

9. A computer system for generating depth information from streaming video, comprising:
one or more processors; and
one or more non-transitory computer-readable media having stored thereon executable instructions that when executed by the one or more processors configure the computer system to perform at least the following:
receive a sequence of video frames;
generate spatially detailed depth-related features from a higher-resolution representation of a current video frame selected from the sequence of video frames using a first transformer-based encoder;
generate semantically informative depth-related features from a lower-resolution representation of the current video frame using a second transformer-based encoder;
generate refined spatially detailed depth-related features by selectively incorporating, via a feature-interaction module, the semantically informative depth-related features into the spatially detailed depth-related features;
generate a dense feature representation for the current video frame from the refined spatially detailed depth-related features using one or more transformer-based depth prediction modules;
temporally align the dense feature representation for the current video frame using a stateful temporal alignment model that maintains a state derived from previously processed video frames, the temporally aligning including generating one or more alignment parameters configured to enforce depth-scale consistency across frames and applying the one or more alignment parameters to the dense feature representation or to depth values derived therefrom, without access to future video frames; and
generate a depth map for the current video frame from the temporally aligned dense feature representation.

10. The computer system of claim 9, wherein the stateful temporal alignment model comprises a selective state-space model.

11. The computer system of claim 10, wherein the selective state-space model maintains an internal state that is updated based on the dense feature representation of the current video frame.

12. The computer system of claim 10, wherein the one or more alignment parameters comprise a uniform scale factor and a uniform shift factor applicable across the current video frame.

13. The computer system of claim 12, wherein the selective state-space model comprises a linear-time sequence model.

14. The computer system of claim 12, wherein the uniform scale factor and the uniform shift factor are generated for the current video frame based on the state derived from the previously processed video frames.

15. The computer system of claim 12, wherein the uniform scale factor and the uniform shift factor are each applied uniformly to all pixels of the current video frame.

16. The computer system of claim 12, wherein the selective state-space model aligns the dense feature representations of successive video frames to a common depth scale across the sequence of video frames.

17. The computer system of claim 9, wherein the feature-interaction module comprises a cross-attention mechanism configured to use feature representations from the spatially detailed depth-related features as queries and feature representations generated from the semantically informative depth-related features as keys and values.

18. The computer system of claim 9, wherein the one or more transformer-based depth prediction modules comprise a plurality of decoding stages, and wherein the feature-interaction module is applied after an initial decoding stage and before one or more subsequent decoding stages.

19. The computer system of claim 9, wherein the higher-resolution representation corresponds to a native spatial resolution of the sequence of video frames, and the lower-resolution representation is generated by downsampling the sequence of video frames.

20. The computer system of claim 9, wherein:
the spatially detailed depth-related features correspond to feature representations derived from the higher-resolution representation prior to spatial downsampling, and
the semantically informative depth-related features are derived from the lower-resolution representation to capture scene-level depth relationships.
